(19) United States
(12) Patent Application Publication
(10) Pub. No.: US 2008/0091319 A1
(43) Pub. Date: Apr. 17, 2008

(54) Electric circuit for a by-wire system

(75) Inventors: Troy Eugene Schick, Cedar Falls, IA (US); Joseph Paul Kearney, Cedar Falls, IA (US); Vijay Manilal Dharia, Cedar Falls, IA (US); David Eugene Brandon, Waterloo, IA (US); Roger Michael Hoy, Waterloo, IA (US)

Correspondence Address: DEERE & COMPANY, ONE JOHN DEERE PLACE, MOLINE, IL, 61265, US

(73) Assignee: Deere and Company

(21) Appl. No.: 11/581,813

(22) Filed: Oct. 17, 2006

(51) Int. Cl. B62D 5/04

(52) U.S. Cl. 701/41; 180/443

(57) ABSTRACT

The invention relates to an electrical system or circuit for a by-wire control system. The control system includes a hydraulic pump, a reservoir, a bi-directional function actuator, and solenoid operated valves for controlling the actuator in response to control signals from the electronic system. The electronic system includes first and second pairs of command device position sensors, a first channel and a second channel. Each channel includes main processing unit and a supervisory control unit. Each main processing unit is connected to a pair of the command device position sensors, and a pair of the solenoid operated valves.

### BACKGROUND

The present invention relates to a electric circuit or system for a function-by-wire system, such as a steer-by-wire or brake-by-wire system.

Steer or brake-by-wire systems in vehicles eliminate the mechanical link between the steering wheel (or the brake pedals) and the road wheels, and permit the system to achieve a desirable steering “feel” or other control characteristic. Such “by-wire” systems have been difficult to implement in vehicles because of cost, reliability and precision requirements.

Such a system must be design to function despite the occurrence of a single point failure in the electrical system. Input sensor information must be reliably shared between redundant system channels. The aerospace industry satisfies this communication requirement by utilizing redundant time-deterministic communication busses. However, such determinant busses are expensive, are not currently produced at mobile equipment volumes, and have not been standardized on a common protocol.

### SUMMARY

Accordingly, an object of this invention is to provide a electric system for a -by-wire system.

A further object of the invention is to provide such a system which is fault tolerant and which is cost effective.

These and other objects are achieved by the present invention, wherein a electric system is provided for a steer-by-wire steering system having a steering wheel, a pump, a reservoir, and a bi-directional steering actuator having left and right inlets, an electro-hydraulic valve system including solenoid operated valves.

An electronic system includes first and second pairs of steering wheel position sensors. The electronic system also includes a first channel and a second channel. The first channel includes a first main processing unit and a first supervisory control unit. The first main processing unit is connected to the first pair of steering wheel position sensors, to a first left directional control valve input, to a first right directional control valve input, to valve position sensors, and to the solenoid of a first shut-off valve.

The second channel includes a second main processing unit and a second supervisory control unit. The second main processing unit is connected to the second pair of steering wheel position sensors, to another left directional control valve input, to another right directional control valve input, to valve position sensors, and to the solenoid of a second shut-off valve.

The supervisory control units are connected to the sensors, to each other, to the main processor units, and to the solenoids of the shut-off valves.

The main processor units generate directional control signals for directional control valves as a function of the steering wheel position sensors.

In response to fault condition in the first directional control valve or in a portion of the system associated with the first directional control valve unit, the first channel closes the first shut-off valve so that the actuator is controlled only by the second directional control valve unit.

In normal conditions, the solenoids of the shut-off valves are both energized so that both directional control valve unit share in the control of hydraulic flow to and from the actuator 12. However, if a fault occurs the shut-off valve in the failing portion of the circuit is de-energized and allowed to close, so that the actuator can be controlled solely by the directional control valve unit in the non-failing portion of the circuit.

### BRIEF DESCRIPTION OF THE DRAWINGS

FIG. 1 is a schematic diagram of a hydraulic circuit for a steer-by-wire steering system according to the present invention; and

FIG. 2 is a schematic diagram of an electronic system or circuit for a steer-by-wire steering system according to the present invention.

### DETAILED DESCRIPTION

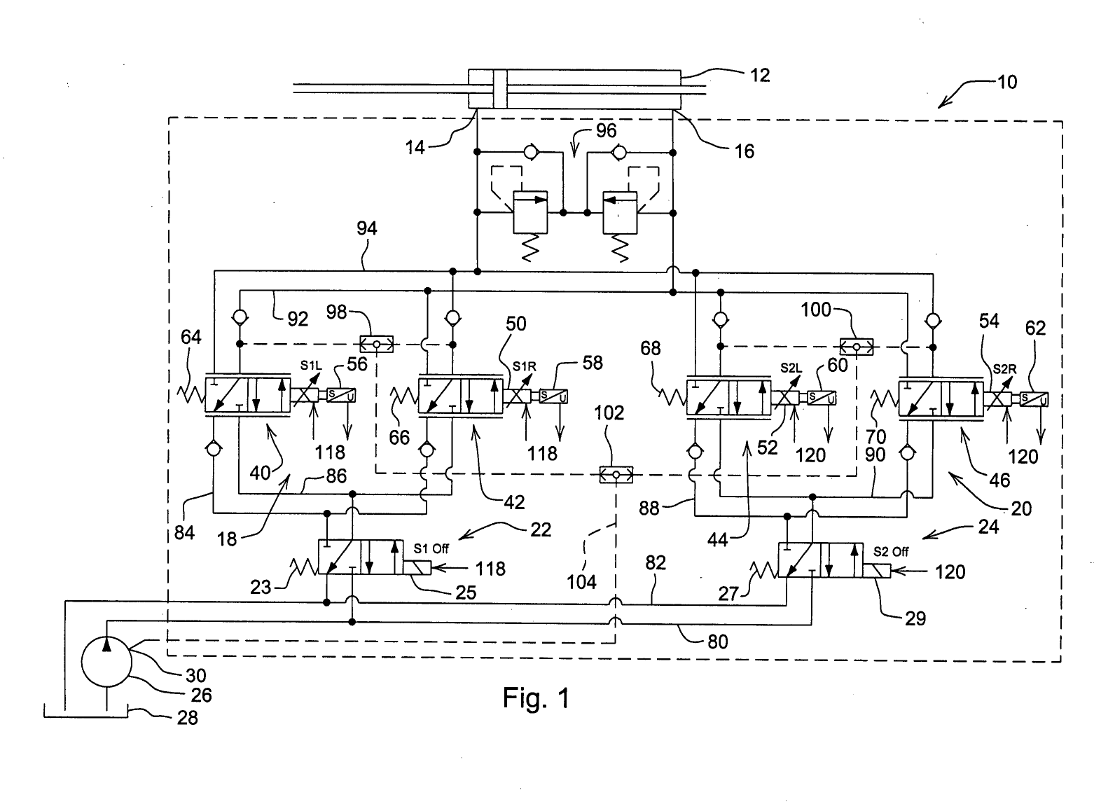

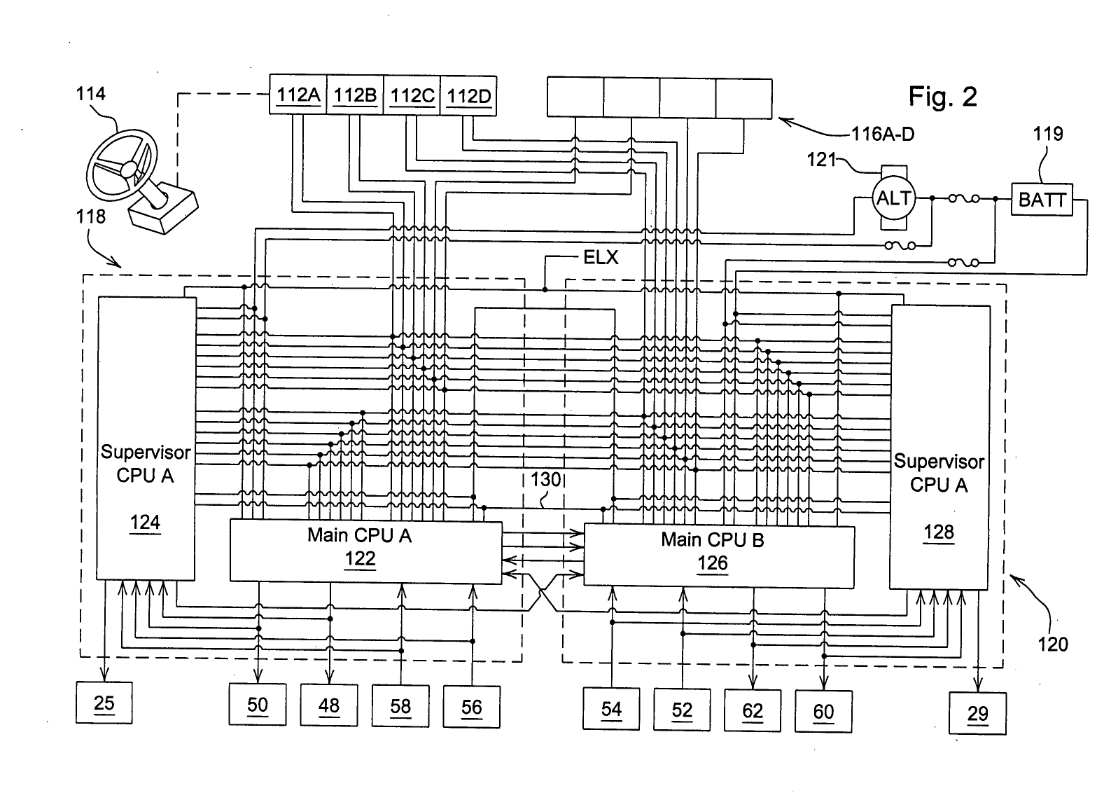

Referring to the FIG. 1, a steer-by-wire electronic system or circuit 10 includes a bi-directional hydraulic steering cylinder or function actuator 12 connected to vehicle components or steerable wheels (not shown) and with left and right inlet ports 14 and 16. System 10 also includes first and second solenoid operated directional control valve units 18 and 20, first and second shut-off valves 22 and 24, a pump 26 and a reservoir 28. Pump 26 includes a load sense port 30. Valve units 18 and 20 and shut-off valves 22 and 24 are connected and controlled by first and second electronic control units shown in FIG. 2.

Valve 22 includes a spring 23 and a solenoid 25, and valve 24 includes a spring 27 and a solenoid 29.

Valve unit 18 includes first and second solenoid operated 4-way, 2-position proportional valves 40 and 42. Valve unit 20 includes first and second solenoid operated 4-way, 2-position proportional valves 44 and 46. Each valve 40-46 includes a solenoid 48-54, a valve position sensor 56-62, and a spring 64-70. The valves are preferably small low-cost cartridge type valves. The valve position sensors 56-62 may be commercially available LVDT (linear variable differential transformer) type spool position sensors, or a suitable similar position sensor.

Lines 80 and 82 connect the pump 26 and reservoir 28, respectively, to inlet ports of shut-off valves 22 and 24. Line 84 connects a first outlet of shut-off valve 22 to inlets of valves 40 and 42. Line 86 connects a second outlet of shut-off valve 22 to inlets of valves 40 and 42. Line 88 connects a first outlet of shut-off valve 24 to inlets of valves 44 and 46. Line 90 connects a second outlet of shut-off valve 24 to inlets of valves 44 and 46. Check valves in lines 84 and 88 permit one-way fluid flow therethrough to shut-off vales 22 and 24.

Line 92 connects right actuator inlet 16 to an outlet of each of valves 40-46. Line 94 connects left actuator inlet 14 to an outlet of each of valves 40-46. Check valves in line 92 permit one-way fluid flow therethrough from valves 40 and 44 to actuator right inlet 16. Check valves in line 94 permit one-way fluid flow therethrough from valves 42 and 46 to actuator left inlet 14.

A relief and check valve circuit 96 operates in a known manner to limit pressure in the actuator 12 and in lines 92 and 94, such as when a steerable wheel (not shown) strikes an object, such a stump. Shuttle check valves 98, 100 and 102 communicate the highest pressure in the branches of lines 92 and 94 to the line sense port 30 of pump 26 via load sense line 104.

In an alternate embodiment (not shown) each of valve units 18 and 20 may include only a single 4-way, 3-position, spring-centered, dual solenoid operated valve.

Turning now to FIG. 2, the electrical system or circuit 110 includes a plurality (preferably 4) of redundant steering wheel or command device sensors 112A-D operatively connected to a steering wheel 114. Front redundant wheel angle sensors 116A-D are operatively connected to steerable front wheels (not shown). Sensors 112 are preferably commercially available position sensors, while sensors 116 may be analog Hall effect or potentiometer type rotary angle sensors.

Pairs of each of sensors 112 and 116 are connected, respectively, to a first channel 118 and a second channel 120. First channel 118 includes a first main processing unit 122 and a first supervisory control unit 124. The first main processing unit 122 and first supervisory control unit 124 are connected to steering wheel position sensors 112A and 112B, to wheel angle sensors 116A and 116B, to solenoids 48 and 50, and to valve position sensors 56 and 58. The first supervisory control unit 124 is also connected to solenoid 25 of shut-off valve 22.

Second channel 120 includes a second main processing unit 126 and a second supervisory control unit 128. The second main processing unit 126 and the second supervisory control unit 128 are connected steering wheel position sensors 112C and 112D, to wheel angle sensors 116C and 116D, to solenoids 52 and 54, and to valve position sensors 60 and 62. The second supervisory control unit 128 is also connected to solenoid 29 of shut-off valve 24. A dedicated CAN bus 130 communicates non safety critical information, such as diagnostics and/or reprogramming, between the channels 118 and 120. Channels 118 and 120 are also connected to a conventional vehicle battery 119 and an alternator 121.

The main processor units 122 and 126 generate control signals (preferably pulse width modulated “PWM”) for the solenoids of the directional control valve units 18 and 20 as a function of the sensed position of the steering wheel 114 and of the steered wheels (not shown). The supervisor processor units 124 and 128 control the shut-off valves 22 and 24 and operate to isolate the channels 118 and 120 from each other. The supervisor processor units 124 and 128 also monitor the health or condition of both channel by direct monitoring of the PWM outputs of the main processor units 122 and 126.

Lines 132 include the following connections between the controllers: supervisor 124 to main 122, main 122 to main 126, main 126 to main 122, supervisor 128 to main 122. These lines communicate pulse width modulated (PWM) signals between the main and supervisor processors, and when one of the processor detects a fault, that processor communicates the existence of that fault to the other processors by changing the duty cycle of the PWM signal communicated to the other processors. This information allows either channel to understand the health of the opposite channel, and to take the appropriate control action.

In normal conditions, the solenoids of valves 22 and 24 are both energized and valve unit 18 (valves 40 and 42) and valve unit 20 (valves 44 and 46) are all operated to share in the control of hydraulic flow to and from the actuator 12. However, if a fault occurs in valve unit 18 or in the circuitry associated with valve unit 18, then processor 124 will deactivate shut-off valve 22, and all the flow to actuator 12 will flow through shut-off valve 24 and will be controlled by valve unit 20 (valves 44 and 46). Similarly, if a fault occurs in valve unit 20 or in the circuitry associated with valve unit 20, then processor 128 will deactivate shut-off valve 24, and all the flow to actuator 12 will flow through shut-off valve 22 and will be controlled by valve unit 18 (valves 40 and 42).

Thus, the system of this invention includes two nearly identical electric (redundant) channels to guarantee the system functions in the event of a single component failure. In each channel, the main processor is responsible for controlling the directional steering control valves, and the supervisor processor controls the shut-off valve of the associated channel.

Critical input sensor information is communicated directly by a hardwired connection between the sensors and both channels.

In this system, all of the steering-related input sensor signals are communicated to both main and to both supervisor processors. Both the supervisor and main processors can calculate a steering valve control signal, but only main processors are connected to the steering control valves. However, the supervisor processors can monitor the steering control signals generated by the main processors, and can disable oil flow (isolate/shutoff) if a main processor generates an unrealistic or invalid control signal.

While the present invention has been described in conjunction with a specific embodiment, it is understood that many alternatives, modifications and variations will be apparent to those skilled in the art in light of the foregoing description. For example, this invention could be used in a variety of “by-wire” systems, such as a brake-by-wire system, as well as a steer-by-wire system. Accordingly, this invention is intended to embrace all such alternatives, modifications and variations which fall within the spirit and scope of the appended claims.

We claim:

1. An electronic system for a by-wire function control system, the function control system including a function actuator coupled to a vehicle component, an electro-hydraulic actuator control system having first and second electro-hydraulic directional control valve units and a pair of shut-off valves, each operable to disable a respective one of the directional control valve units, and an operator controlled function command unit, the electronic system comprising:
a plurality of command unit position sensors;
a first channel comprising a first main processing unit and a first supervisory control unit, the first main processing unit being connected to the first set of the command unit position sensors and to a first one of the directional control valve units; and
a second channel comprising a second main processing unit and a second supervisory control unit, the second main processing unit being connected to a second set of the command unit position sensors and to a second one of the directional control valve units, the first main processor unit generating control signals for the first directional control valve unit as a function of the first set of position sensors, and the second main processor unit generating control signals for the second directional control valve unit as a function of the second set of position sensors, each supervisory control unit being connected to all of the position sensors, to both main processing units, each supervisory control unit, in response to detection of a fault condition, causing a respective one of the shut-off valves to disable a respective one of the directional control valve units.

2. The electronic system of claim 1, further comprising:
a plurality of component position sensors, the first main processing unit being connected to a first set of the component position sensors, and the second main processing unit being connected to a second set of the component position sensors.

3. The electronic system of claim 1, wherein:
each supervisory control unit is connected to a respective one of the directional control valve units.

4. An electronic system for a steer-by-wire steering system, the steering system including a bi-directional steering actuator coupled to a steerable wheel, an electro-hydraulic actuator control system having first and second electro-hydraulic directional control valve units and a pair of shut-off valves, each operable to disable a respective one of the directional control valve units, and an operator controlled steering wheel, the electronic system comprising:
a plurality of steering wheel position sensors;
a first channel comprising a first main processing unit and a first supervisory control unit, the first main processing unit being connected to the first set of the steering wheel position sensors and to a first one of the directional control valve units; and
a second channel comprising a second main processing unit and a second supervisory control unit, the second main processing unit being connected to a second set of the steering wheel position sensors and to a second one of the directional control valve units, the first main processor unit generating control signals for the first directional control valve unit as a function of the first set of steering wheel position sensors, and the second main processor unit generating control signals for the second directional control valve unit as a function of the second set of steering wheel position sensors, each supervisory control unit being connected to all of the steering wheel position sensors, to both main processing units, each supervisory control unit, in response to detection of a fault condition, causing a respective one of the shut-off valves to disable a respective one of the directional control valve units.

5. The electronic system of claim 4, further comprising:
a plurality of steered wheel position sensors, the first main processing unit being connected to a first set of the steered wheel position sensors, and the second main processing unit being connected to a second set of the steered wheel position sensors.

6. The electronic system of claim 4, wherein:
each supervisory control unit is connected to a respective one of the directional control valve units.
